(19) United States
(12) Patent Application Publication
(10) Pub. No.: US 2013/0253980 A1
(43) Pub. Date: Sep. 26, 2013

(54) METHOD AND APPARATUS FOR ASSOCIATING BRAND ATTRIBUTES WITH A USER

(71) Applicants: Jan Otto Blom, Lutry (CH); Julian Nolan, Pully (CH)

(72) Inventors: Jan Otto Blom, Lutry (CH); Julian Nolan, Pully (CH)

(73) Assignee: Nokia Corporation, Espoo (FI)

(21) Appl. No.: 13/425,017

(22) Filed: Mar. 20, 2012

(51) Int. Cl. G06Q 30/02

(52) U.S. Cl. 705/7.29

(57) ABSTRACT

An approach is provided for associating one or more attributes of a brand with one or more users. A brand association platform determines one or more attributes for one or more branded objects associated with at least one user, at least one device associated with the at least one user, or a combination thereof. The brand association platform then processes and/or facilitates a processing of the one or more attributes to determine profile information associated with the at least one user, the at least one device, or a combination thereof.

### BACKGROUND

Service providers and device manufacturers (e.g., wireless, cellular, etc.) are continually challenged to deliver value and convenience to consumers by, for example, providing compelling network services. One area of interest is providing customized services and device features based on analysis of consumer behavior and perceptions of the brands they consume. Typically, individuals use objects such as clothes, cars, music, etc., including those associated with specific brands, to reinforce their identity or strengthen the image they want to project. The attributes associated with the brand such as “prestigious,” “hip” or “high-end,” are often accepted by the consumer and others as attributes they associate with themselves. Unfortunately, there is currently no convenient means of enabling users to perform various device actions or access services from their device based on this association. Furthermore, service providers have no convenient means of associating various brand attributes with consumers of their products.

### SOME EXAMPLE EMBODIMENTS

Therefore, there is a need for an approach for associating one or more attributes of a brand with one or more users.

According to one embodiment, a method comprises determining one or more attributes for one or more branded objects associated with at least one user, at least one device associated with the at least one user, or a combination thereof. The method further comprises processing and/or facilitating a processing of the one or more attributes to determine profile information associated with the at least one user, the at least one device, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine one or more attributes for one or more branded objects associated with at least one user, at least one device associated with the at least one user, or a combination thereof. The apparatus is further caused to process and/or facilitate a processing of the one or more attributes to determine profile information associated with the at least one user, the at least one device, or a combination thereof.

According to another embodiment, a computer-readable storage medium carries one or more sequences of one or more instructions which, when executed by one or more processors, cause, at least in part, an apparatus to determine one or more attributes for one or more branded objects associated with at least one user, at least one device associated with the at least one user, or a combination thereof. The apparatus is further caused to process and/or facilitate a processing of the one or more attributes to determine profile information associated with the at least one user, the at least one device, or a combination thereof.

According to another embodiment, an apparatus comprises means for determining one or more attributes for one or more branded objects associated with at least one user, at least one device associated with the at least one user, or a combination thereof. The apparatus further comprises means for processing and/or facilitating a processing of the one or more attributes to determine profile information associated with the at least one user, the at least one device, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of associating one or more attributes of a brand with one or more users, according to one embodiment;

FIG. 2 is a diagram of the components of a brand association platform 103, according to one embodiment;

FIGS. 3A-3D are flowcharts of a process for associating one or more attributes of a brand with one or more users, according to various embodiments;

FIGS. 4A-4H are diagrams depicting various use cases for associating one or more attributes of a brand with one or more users, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for associating one or more attributes of a brand with one or more users, according to various embodiments are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

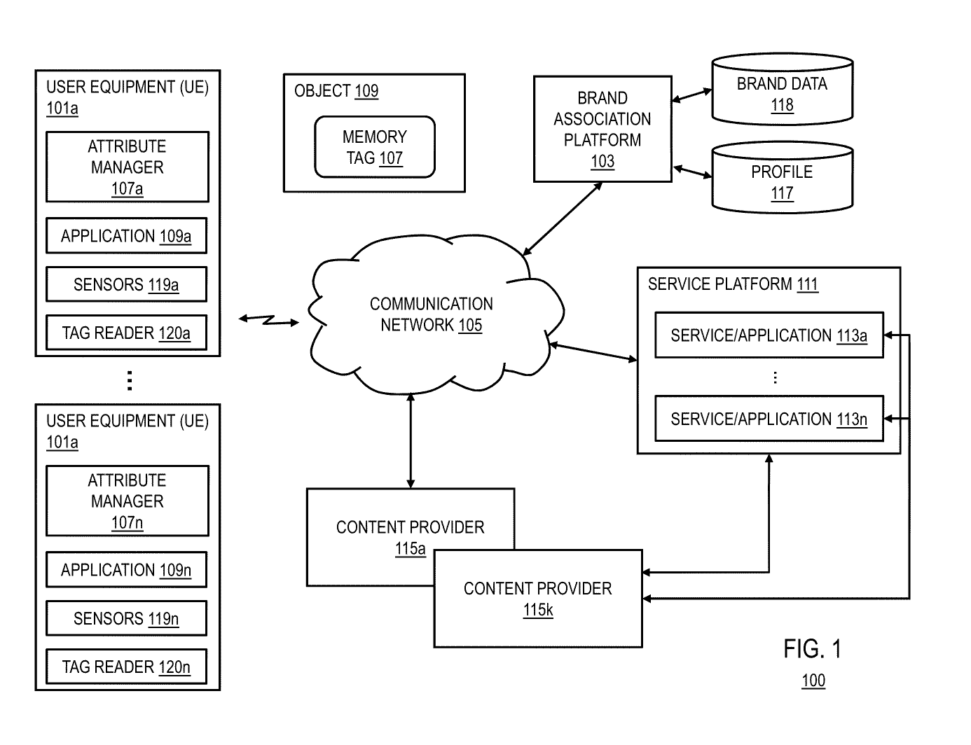

FIG. 1 is a diagram of a system capable of associating one or more attributes of a brand with one or more users, according to various embodiments, according to one embodiment. As discussed previously, consumers typically associate or identify themselves with various brands or branded objects as a means of self expression. Preferred brands are typically associated with a set of attributes which are attractive to the user, and with which they want to be associated. For instance, by associating oneself with a particular brand of luxury vehicle, an individual may attempt to convey to others they are sporty, luxury-driven and affluent. As another example, a consumer may loyally purchase clothing items of a specific brand to assert they possess a sense of style or belong to the same genre as the branded clothing suggests. Still further, users of a social networking service (e.g., Facebook) may choose to represent themselves online using certain names and/or logos affiliated with a brand. They may even align themselves with other users affiliated with the same brand; all of which is intended to influence how they are perceived. Hence, there is often a strong psychological disposition among users of brands to associate qualities or characteristics they attribute with the brand with themselves.

Unfortunately, there is currently no convenient means of enabling users to perform various device actions or access services from their device based on this predisposition towards certain brands or branded objects. This is due, in part, to the inability of the device or services of the device to accurately determine the one or more attributes associated with the brands or branded objects the user interacts with. Furthermore, device application and/or service providers have no convenient means of associating various brand attributes with the consumer. As a result, providers of applications and services for device users are limited in their ability to customize features and services they offer based on the attributes of the various brands enjoyed by their customers.

To address this problem, a system 100 of FIG. 1 introduces the capability to automatically recognize the brand affiliations of a user of a device, i.e., user equipment 101a-101n (referred to collectively as UE 101), as well as determine various attributes associated with those brands. By way of example, the attributes determined to be associated with a given brand may include one or more terms, images, sounds or other descriptor types for conveying or suggesting a theme, quality, feature, or other distinguishing characteristic. For example, a luxury car offered as a branded object affiliated with a particular brand may be associated with various attributes such as “luxury,” “high-end,” “premium.” In addition, the attributes may describe various demographic, economic or social qualifiers, such as “wealthy,” “affluent,” or “upscale.” These attributes may then be utilized by various applications 109a-109n (referred to collectively as application 109) of the UE 101, one or more corresponding services/applications 113a-113n (referred to collectively as services/applications 113) accessible by UE 101, or a combination thereof for facilitating various device, application and/or service features.

The system 100 features a brand association platform 103 that operates in connection with one or more UE 101 to perform one or more of the following: (a) determine user interaction with a specific branded object based on metadata, contextual data, of the like as collected by various sensors 119 of the UE 101 of pursuant to reading of a memory tag 107 by the UE 101 or other device of the user; (b) identify a brand associated with the branded object for enabling cross-referencing of the branded object against brand data 118 for linking branded objects to their brands and attributes associated therewith; (c) facilitate the associating of the one or more attributes determined to be affiliated with the brand and/or branded object with profile information 117 maintained for the user; (d) facilitate the continual retrieval of attributes associated with a brand and/or branded object from a specified list of content providers 115a-115k (referred to collectively as content providers 115); (e) facilitate the continual updating, ranking, prioritizing and organizing of the one or more attributes on a periodic or on demand basis for ensuring consistent relevancy of the attributes corresponding to a brand and therefore, a set of user profile information. The profile information may then be utilized by various applications 109a-109n (referred to collectively as application 109) of the UE 101, one or more corresponding services/applications 113a-113n (referred to collectively as services/applications 113) accessible by UE 101, or a combination thereof to facilitate various device, application and/or service features based on the attributes.

As depicted in FIG. 1, UE 101 features various sensors 119a-119n (referred to collectively as sensors 119) for enabling the detecting of user interaction with or use of a branded object. In certain embodiments, the sensors 119 may include, for example, a camera/imaging sensor for gathering image data, an audio recorder for gathering audio data, a global positioning sensor for gathering location data, a position sensor or gyroscope for detecting device orientation and/or tilt, a network detection sensor for detecting wireless signals or network data, temporal information and the like. This information is provided to the brand association platform 103 for processing to determine contextual information associated with the user, a branded object associated with the user, the UE 101, or a combination thereof. In certain embodiments, the contextual information may be used in connection with information regarding a brand or branded object 109 to determine user behavior at the moment with respect to the object 109

By way of example, user interaction with a branded object 109 may be facilitated by way of capture of an image of a barcode, quick response code (QR) code or other code or identifier affixed to a branded object 109 by UE 101. The image capture may be performed in connection with a code reader application 109 or purchase transaction service/application 113. Upon scanning the code, it is processed by the brand association platform 103 or another service based on known code and image data recognition techniques for determining a brand associated with the code. Under this scenario, the code provides various metadata for indicating one or more general characteristics of the object, including the brand, the manufacturer of the brand, product information such as product type, various logistic data, promotional information, etc. Upon determining the brand and/or branded object type, the brand association platform 103 is able to refer to brand data 118 corresponding to the object 109. Also, in the case where temporal information associated with the image is determined to correspond to a time condition (e.g., after 5 pm), this contextual information me be used to drive decisions related to the use of profile information 117.

As another example, a tag reader 120a-120n (referred to collectively as a tag reader 120a) detects a radio frequency (RF) memory tag 107 associated with an object 109. The memory tag 107 is a location independent object, which upon being read causes transference of metadata, promotional data, or any other information to device featuring the tag reader 120. Reading of the tag may be facilitated through physical activation of memory tags, including tagging, touching or other contact by a tag processing capable device or via a proximity/presence detection capability of the device (e.g., near field communication, short range communication). Upon detection, the tag reader 120a reads the metadata to determine the brand and/or branded object type and initiates communication with the brand association platform 103. As noted above, the brand association platform 103 is then able to refer to brand data 118 corresponding to the object 109.

In one embodiment, the brand data 118 may include an index of various branded objects, their associated brand, a manufacturer of said brand and one or more attributes associated with said branded object and/or brand. The index is able to be queried by the brand association platform 103 based on a provided input—i.e., a brand and/or branded object type as indicated from reading of a memory tag 107 or from interacting with said object 109 via the UE 101. The one or more attributes associated with the specified brand and/or branded object 109 is then maintained by the index. Attributes stored in association with a brand and/or branded object 109 to the brand database 118 is retrieved by the brand association platform 103 from various content providers 115.

In one embodiment, the content providers 115 act as hosts of one or more websites, social networking services, blogs, advertising materials, review information, data feeds, or sources of other information and/or documents. By way of example, the information and/or published documents provided by the content providers 115 feature the name, symbol, image or sound associated with a brand and/or various objects affiliated with that brand. The content providers 115 are designated as sources of information regarding the various attributes of a brand by the manufacturer of the brand. It is also contemplated, in certain implementations that the user is able to specify the source from which various attributes are retrieved in connection with their profile information 117.

Attributes are retrieved/extracted from the various sources provided by the content providers 115 based on processing of the information by the brand association platform 103. For example, the returned information and/or documents pertaining to a brand and/or branded object may be ranked based on various criteria, such as the date and time of publishing of the document and/or information, the total number of occurrences of a particular attribute term throughout the document and/or information, a popularity value associated with the document and/or information, or a combination thereof. Data representing these criteria may be provided as input for generating a ranking value based on a ranking and/or categorization algorithm. The documents and/or information ranked first (e.g., within the top 10 of all retrieved documents and/or information) is then selected for further analysis by the brand association platform 103—i.e., to determine the most prevalent terms used in association with the brand. By way of this approach, for example, those terms identified most frequently within the most documents and/or sets of information are deemed to be the attributes associated with the brand and/or branded object. Resultantly, these attributes are stored in association with the brand and/or branded object for enabling execution of queries by the brand association platform 103.

It is noted that the attributes may be computed in real-time in response to a query generated by metadata (brand, branded object types, manufacturer information, etc.) being communicated to a UE 101. For example, the documents and/or information maintained by the one or more content providers 115a-115k may be retrieved, analyzed and ranked on demand for determining one or more relevant attributes associated with the branded object, brand or manufacturer. Also, the procedure described for determining the attributes may be iterated a number of times and averaged over a specific time interval, such as to enable the brand association platform 103 to adapt to the changes which can occur in the attributes associated with branded products over time. The frequency of updating or generation of the one or more attributes relative to a brand and/or branded object within the index 118 may be established by the manufacture accordingly, or in certain instances, by the user.

In certain embodiments, the brand association platform 103 may also collect other terms which may, or may not, be related to the brand attributes based on the above described approach. Under this scenario, instead of storing a list of all possible attribute terms within the index maintained as brand data 118, a list of antonym terms may be stored instead. For example, if the attribute term stored in the index was “reliability” in the context of a branded object type of a car, then antonym terms may include might include “problem,” “broken,” or “unreliable.” It is noted that enabling the querying of the brand database 118 on this basis as well as the retrieval of documents and/or information from the content providers on this basis enhances the number of hits and potential relevant data.

Once determined, the attributes are subsequently associated with profile information 117 of the user. The profile information 117 may be established in connection with a subscription process of the user with the brand association platform 103, one or more services/applications 113a-113n, one or more applications 109a-109n of the UE 101, or a combination thereof. By accessing the profile information 117, and thus the attributes, the applications 109 and/or corresponding services 113 may perform various operations to affect the user experience. This includes generating one or more recommendations for selection by the user based on the determined attributes, automatically invoking various application features or actions based on the attributes, initiating the rendering of one or more offers and incentives associated with the brands and/or branded objects detected, or the like.

For instance, the attributes may be used by one or more advertisers, marketers or the manufactures of various brands to generate targeted advertisements that feature the attributes the user feels applies to them and therefore perceives in a positive manner. This may be carried out, for example, by an advertising widget or application that operates independently or in connection with another application 109. Under this scenario, the widget retrieves profile information, and then determines which targeted advertisements to present to the user based on a match between the advertisements and the established attributes of the user. Alternatively, the widget may create a customized advertisement by processing the one or more attributes with respect to an advertisement template.

As another example, when the application 109 is a mapping application, it can retrieve and analyze the profile information 117 to generate routes, travel destinations or maps based on the brand attributes associated with the user. Under this scenario, in addition to generating a traditional route based on the shortest distance, fastest travel time, scenic route, etc., the mapping application may present various route selections that feature points-of-interest or route information based on the brand attributes of “luxury” or “adventure.” In addition, contextual information may be processed in connection with the attributes for determining additional actions programmed and/or allowed to be executed by the mapping application, such as the offering of one or more coupons for stores within proximity to the user or along the route, enabling the playback of music corresponding to the theme of “adventurous” or “luxurious” during the route, or other actions. It is noted, in this example, that the profile information enables the mapping application to influence locations and geo-routines by selecting those locations and geo-routines which are found to have attributes aligned with the user.

As yet another example, a user of UE 101 may transfer images from UE 101 to their high-definition (HD) television for viewing. As a result of the transfer, metadata is shared with the UE 101 for identifying the television as being a specific branded object type made by a particular manufacturer. Resultantly, the brand association platform 103 is able to perform a lookup of the associated branded object and manufacturer via the brand data 118; to identify one or more associated attributes. Under this scenario, the brand attributes of “high-end”, “expensive”, “technology leadership” and “quality” are returned to the imaging application of the UE 101 in connection with the brand association platform 103. One or more recommendations for additional “high-end” accessories available for purchase or a website of a local club of enthusiasts of the same television brand is rendered to the display of the UE 101.

In certain embodiments, the brand association platform 103 also enables generation of one or more identity tokens on the basis of the brand attributes determined to be associated with the user. Identity tokens may include, for example, pictures, avatars, icons and other graphical and/or textual elements that are used to associate users with the brands they endorse, use or like. In addition, the identity tokens may include, for example, audio, badges, multimedia, or any other type of digital media. By way of example, identity tokens can be presented (e.g., displayed) as an icon/graphic or played back (e.g., audibly) by any number of services 113 as a representation of the user. The brand association platform 103 therefore enables brands and user behavior identified in alignment with the brand attributes to be accessed for use in connection with the application. It is noted that the identity tokens may be used by any application 109 and/or corresponding service/application 113 that employs an identity tracker client or where the use of identity tokens is accepted (e.g., a social networking service or e-mail utility).

By way of example, the identity tracker client may be any component of an application 109 and/or service/application 113 for enabling the gathering of contextual data in relation to execution of the application 109 and/or service 113. This may include, for example, a navigation application that gathers global positioning system (GPS) data. Under this scenario, by activating the service the user also consents to automated collection of contextual data—i.e., opt-in to share location information, position information, temporal information, status information, usage information, activity information, etc., as collected via one or more sensors 119. Resultantly, combinations of brand affiliations, brand attributes and brand related behaviors can be translated to an identity token; and used at the discretion of the user for self-presentational purposes on various social networking sites, a computer desktop, as an e-mail client avatar, etc. The user can also use the service and/or application 113 running the identity tracker client to specify which brands they want to be associated with, while the brand association platform 103 enables the identity tokens to be provided for use in connection with the service and/or application 113 as one or more recommendations.

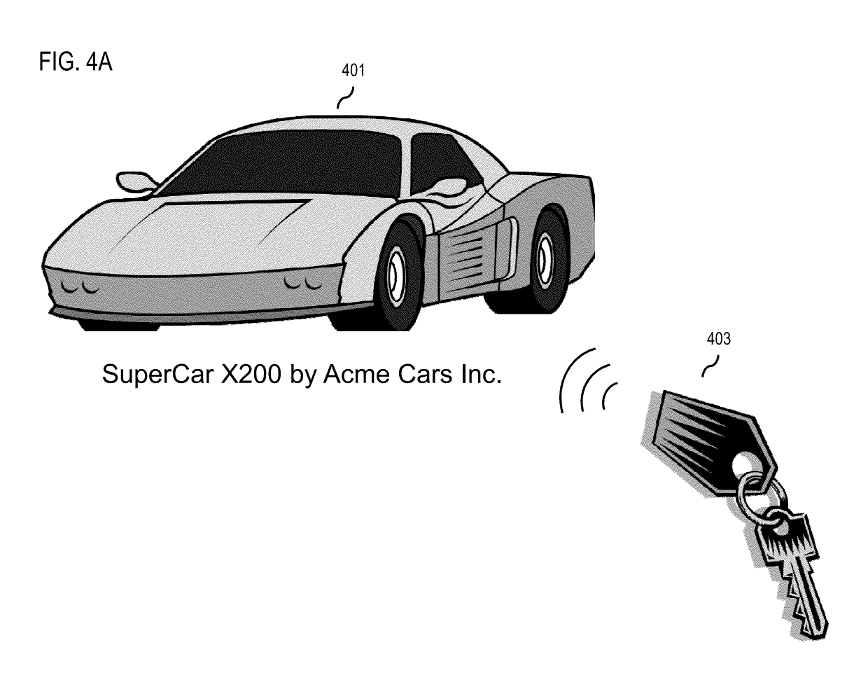

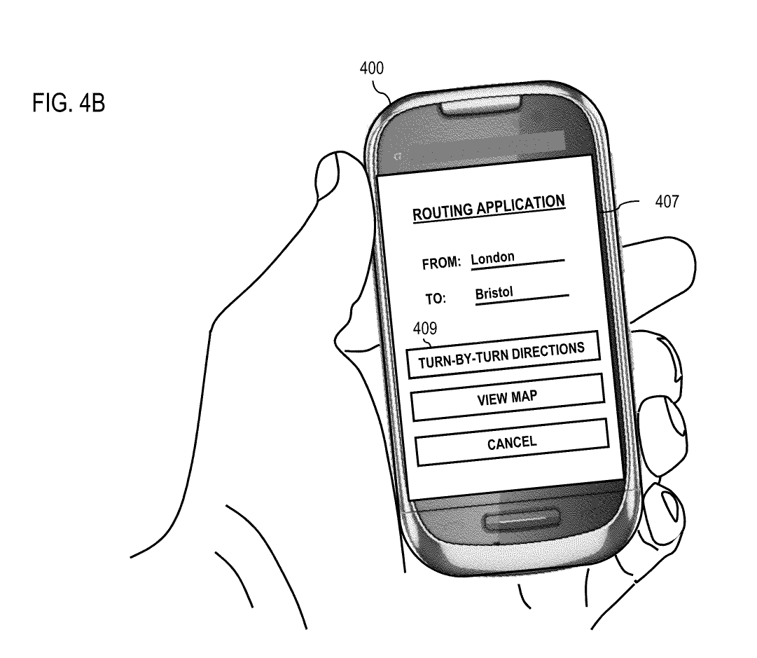

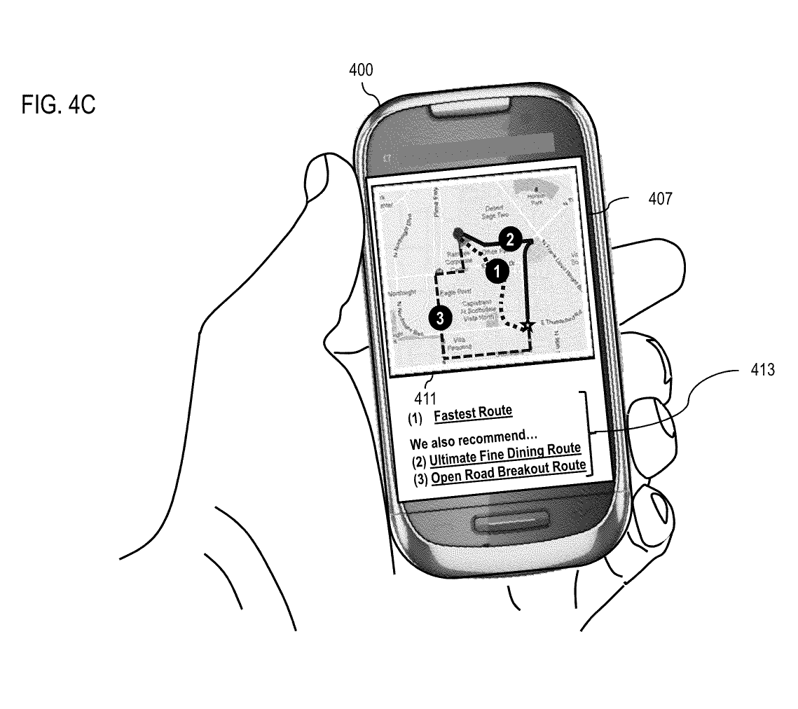

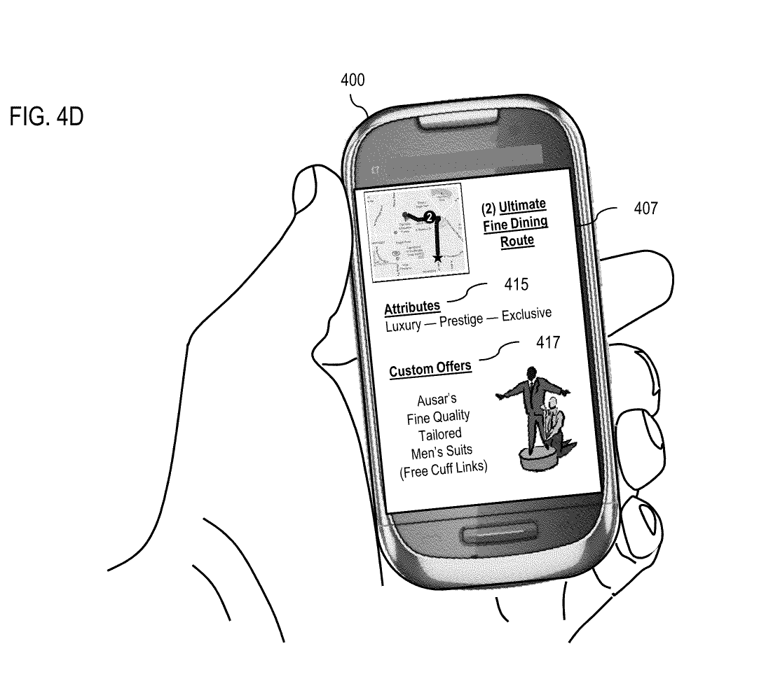

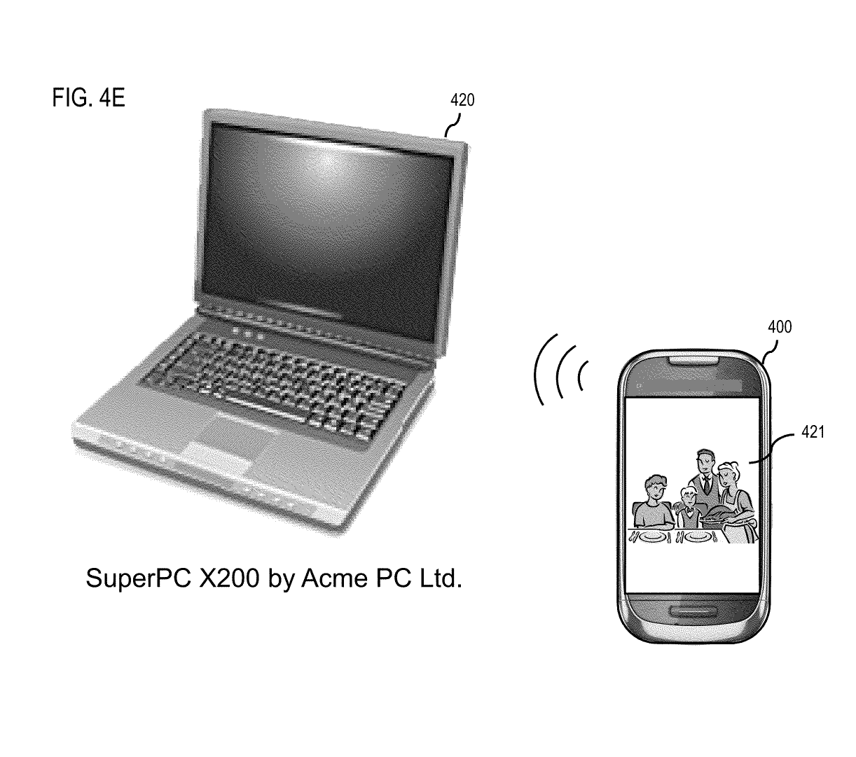

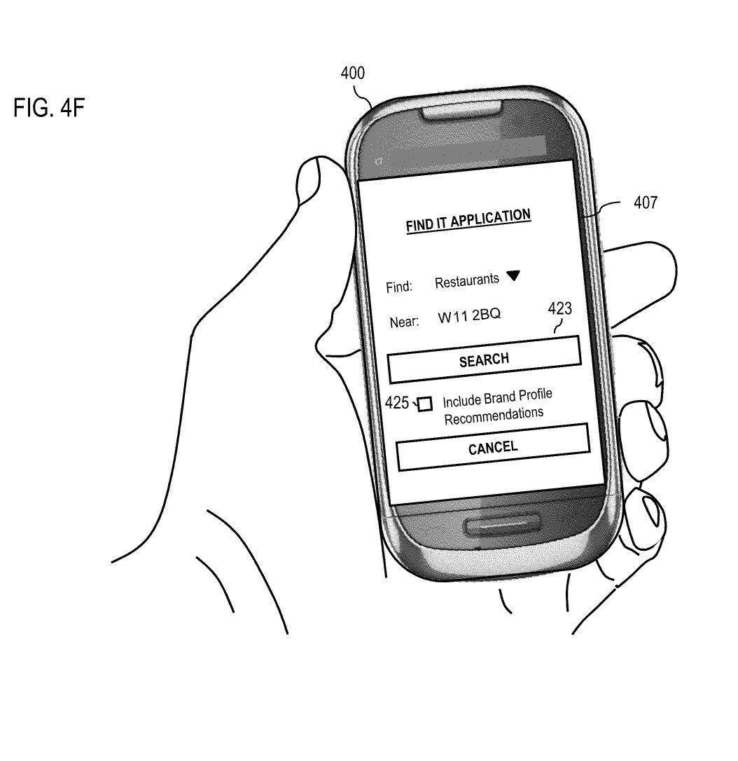

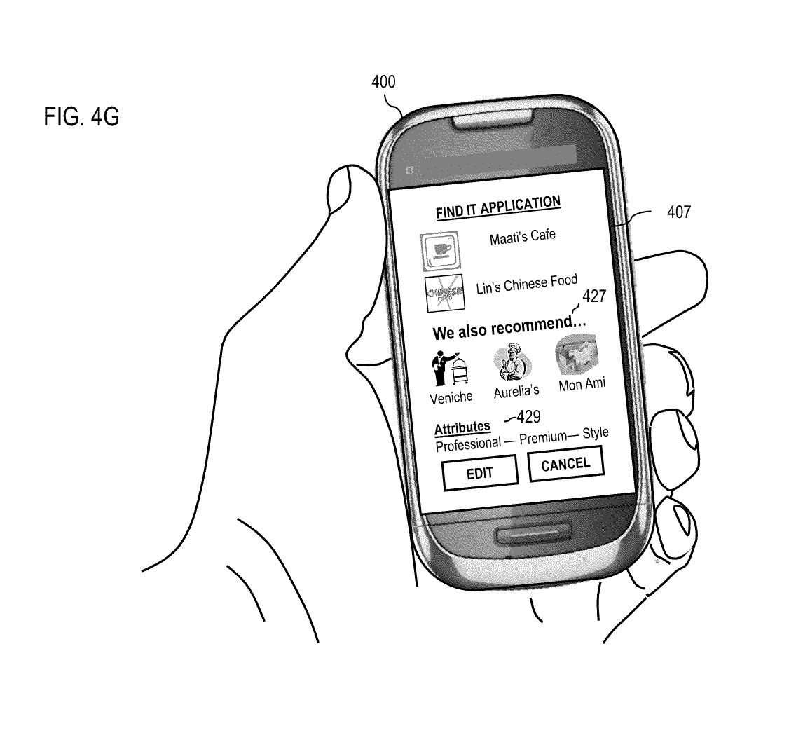

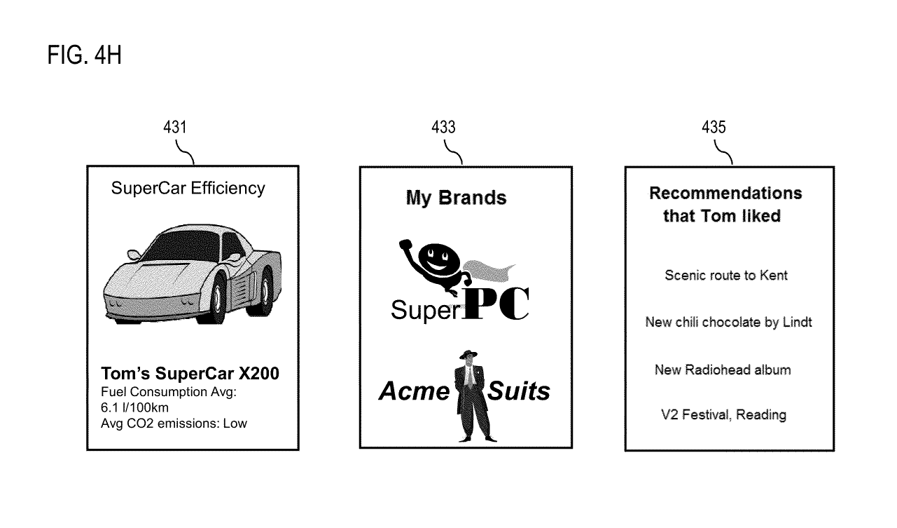

It is noted that the brand association platform 103 enables the contextual data or information extracted from user equipment 101a-101n to be used to determine user behavior and/or personality characteristics that are indicative of the identity of the user. In addition, brand information as conveyed by reading of a memory tag 107 or imaging of a branded object 109 may be correlated with the contextual data for generating the identity token. More regarding the generation and use of identity tokens for reflecting user brand affiliation and attributes thereof is presented more fully later on with respect to FIG. 4H.

As shown in FIG. 1, the system 100 comprises a user equipment (UE) 101 having connectivity to the brand association platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, brand association platform 103, content providers 115 and service platform 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

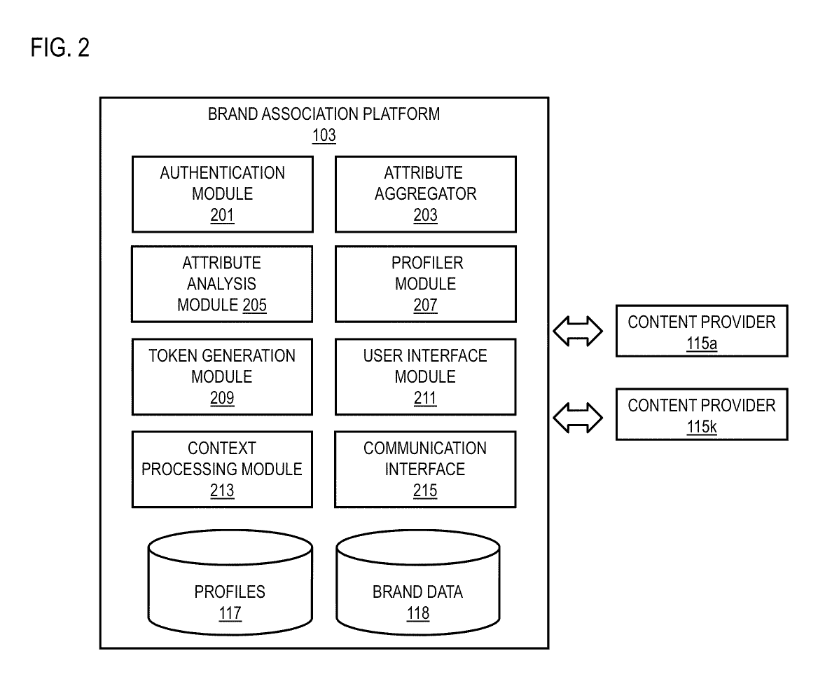

FIG. 2 is a diagram of the components of a brand association platform 103, according to one embodiment. By way of example, the brand association platform 103 includes one or more components for associating one or more attributes of a brand with one or more users. It is contemplated that the functions of these components may be combined in one or more components or performed by other components of equivalent functionality. In this embodiment, the brand association platform 103 includes an authentication module 201, attribute aggregator 203, attribute analysis module 205, profiler module 207, token generation module 209, user interface module 211, content processing module 213 and communication interface 215.

In addition, the various modules of the platform 103 accesses one or more databases for enabling execution of its various functions. These databases include a profile information database 117 for accessing profiling information pertaining to a user of UE 101 and a brand database 118 for maintaining an index of the various brands, branded objects, manufacturers and attributes thereof as used by the user. It is noted that the profile information may or may not be maintained by the brand association platform 103. Rather, it may be maintained by UE 101 or the service platform 111 with respect to various applications of the device. Also, the communication interface 215 may be configured to retrieve documents and/or information pertaining to the one or more brands from various content providers 115.

In one embodiment, an authentication module 201 authenticates users and user devices 101a-101n for interaction with the brand association platform 103. In certain instances, the user may pertain to a consumer of a particular brand, while in other instances, the user may pertain to an application and/or service provider. By way of example, the authentication module 203 receives a request to subscribe to the brand association platform 103 for enabling attributes of brands to be affiliated with a user. The subscription process may include enabling the user to establish various content providers they are affiliated with, preferred location information sharing settings, or a frequency of updating of the attributes. Also, the user may specify which applications may access the profile information 117 for use of the attributes. In the case of enabling the generation of identify tokens by the token generation module 209, various settings and preferences may also include:
1. Services or applications where the identity tokens may be published (e.g., Facebook, LinkedIn, Skype, etc.).
2. Preferred style for the identity tokens (e.g., graphical style, audio style, etc.) to be used in various services or applications (e.g., the user can choose a serious or more playful graphic language, depending on the service the user prefers the identity tokens to be featured in).
3. Pace of updating the identity token in the service or application (e.g., based on the frequency of updating and/or generating of profile information featuring one or more attributes).
4. Privacy settings of the identity tokens (e.g., to establish whether the profile is visible to all service users or limited to a circle of close friends).
   It is noted that the preferences and settings information may be referenced to a specific user, user device, or combination thereof, and maintained as profile information 117.

The authentication process performed by the module 201 may also include receiving and validating a login name and/or user identification value as provided or established for a particular user during a subscription or registration process with the service provider. The login name and/or user identification value may be received as input provided by the user from the user device 101 or other device via a graphical user interface to the platform 103 (e.g., as enabled by user interface module 215). Registration data 217 for respective subscribers, which contains pertinent user or device profile data, may be cross referenced as part of the login process. Alternatively, the login process may be performed through automated association of profile settings maintained as registration data 217 with an IP address, a carrier detection signal of a user device, mobile directory number (MDN), subscriber identity module (SIM) (e.g., of a SIM card), radio frequency identifier (RFID) tag or other identifier.

Still further, the authentication module 201 may also be configured to receive requests from various devices for retrieval of profile information 117. Alternatively, the authentication module 201 may receive request to update and/or generate one or more attributes for association with the profile of a user. By way of this approach, having authenticated the requesting device, application and/or service, the authentication module 201 alerts the attributed aggregator 203 of the request.

In one embodiment, the attribute aggregator 203 retrieves attributes from various designated content providers 115a-115k. By way of example, the attribute aggregator 203 supports the updating and/or generation of the index maintained as brand data 118 with various ranked attribute terms related to a brand and/or branded object. As noted previously, the designated content providers 115a-115k provide access to one or more advertising materials, blog data, social network data, data feeds, reviews, video and audio data, etc., and other information; all of which pertain in whole or part to a particular brand and/or branded object. The attribute aggregator 203 searches for and/or retrieves said information periodically or on demand (e.g., in response to a brand identification request).

Once retrieved, the attribute analysis module 205 ranks the information (e.g., documents) by various criteria, according to one embodiment. By way of example, the ranking may be based on the total number of occurrences of a specific attribute term within a document, the date of the information, etc. Still further, the attributes associated with any given branded object are assigned weights according to the prevalence of each attribute. Hence, if a given user is deemed to own multiple similar object types with different brands, then a set of overlapping and non-overlapping attributes is identified for each branded object. As such, the attribute analysis module 205 is able to account for different brands that are within the same product category (e.g., car manufacturer A's Brand X car versus car manufacturer B's Brand Z car). It is noted that the attributes pertaining to the non-overlapping set for each brand may be utilized—i.e., by a requesting application and/or service—to generate the recommendations based on the distinction in brands and/or branded object types. Conversely, for attributes deemed to have a high weight value but still within an overlapping set, the attribute is assigned under the brand for which the weight is larger. The attributes having the highest ranking and/or weights are deemed to be the attributes associated for a given brand and/or branded object.

In one embodiment, the profiler module 207 processes the one or more attribute terms, as stored via the brand database 103, to determine profile information associated with the at least one user, the at least one device, or a combination thereof. This is done, for example, in response to a request by a calling application and/or service. By way of example, the profiler module 207 cross-references the profile information 109 to determine if at least one of the terms matches that indicated in a user profile. Under this scenario, an attribute term of “luxury” as indicated in a user profile is linked to various additional brands and/or brand objects corresponding to the same attribute.

Still further, the profiler module 207 may operate in connection with the authentication module 201 to enable updating of the profile information to include a reference to one or more brands and/or branded objects having correlated attribute terms. As such, an application, service, or other executable process of the UE may reference the one or more brands and/or branded objects for carrying out various tasks.

In one embodiment, the token generation module 209 generates one or more identity tokens based on the determined brand attributes associated with the user. In addition, the token generation module 209 processes the contextual information as gathered by the context processing module 213 for generating identity tokens representative of brands and determined user behavior. Behavioral characteristics are determined based on processing of sensor information by the context processing module 213, which provides contextual information to the token generation module 209.

By way of example, the identity token may include pictures, avatars, icons and other graphical and/or textual elements that are used to associate users with the brands they endorse, use or like. Tokens are generated for use in connection with one or more services and/or applications designated by the user, such as by way of their profile information 117. The token generation module 209 enables unidirectional or bidirectional communication between identity token creation and the services and/or applications using the identity tokens; including those which utilize an identity tracker client. For example, in one embodiment, on creating an identity token, the module 209 can transmit the identity token to one or more services and/or applications designated by the user without further interaction. In another embodiment, the system 100 may receive feedback from the service and/or application regarding the popularity of a generated identity token. Still further, the module may collect mobility data, application usage data, search history data, activity data, sensor (e.g., gyroscopes, accelerometers, proximity sensors, etc.) data, and other contextual data from the context processing module 213 for determining changes in brand affiliation or attributes of the user.

The token generation module 209 can render a user interface with the determined brand identity tokens for presentation to the user, such as via the user interface module 211. In addition, the token generation module 209 may gather information such as statistics pertaining to the popularity of the identity tokens. This enables the consumer, application and/or service provider, or brand manufacturer to track the frequency at which other users are commenting on the brand identity tokens.

In one embodiment the user interface module 211 enables presentment of a graphical user interface for [presenting the service offering]. By way of example, the user interface module 215 generates the interface in response to application programming interfaces (APIs) or other function calls corresponding to the browser application or web portal application of the user devices 101a-101n; thus enabling the display of graphics primitives.

In one embodiment, a communication module 215 enables formation of a session over a network 109 between the brand association platform 103 and the service platform 111, content providers 115 and respective UE 101. By way of example, the communication module 215 executes various protocols and data sharing techniques for enabling collaborative execution between a subscriber's user device 101a-101n (e.g., mobile devices, laptops, smartphones, tablet computers, desktop computers) and the brand association platform 103 over the network 109. It is noted that the communication module 215 is also configured to support a browser session—i.e., the retrieval of content as referenced by a resource identifier during a specific period of time or usage of the browser.

The above presented modules and components of the brand association platform 103 can be implemented in hardware, firmware, software, or a combination thereof. Though depicted as a separate entity in FIG. 1, it is contemplated that the platform 103 may be implemented for direct operation by respective UEs 101a-101n. As such, the brand association platform 103 may generate direct signal inputs by way of the operating system of the UE for interacting with the browser application 107 and accessing content 109a-109n. Under this scenario, the attribute manager 107 may be configured to perform the various executions of the brand association platform 103. In another embodiment, one or more of the modules 201-221 may be implemented for operation by respective UEs, as a platform 103, or combination thereof.

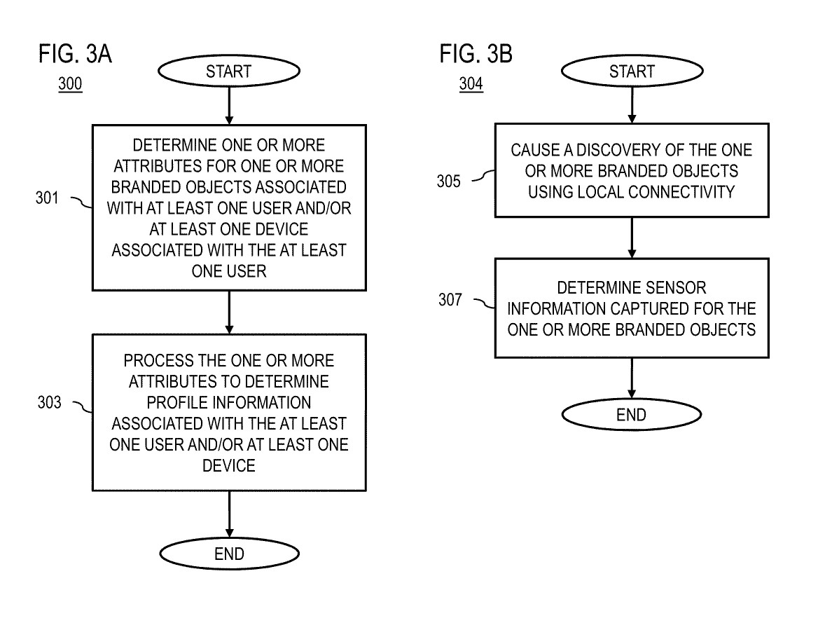

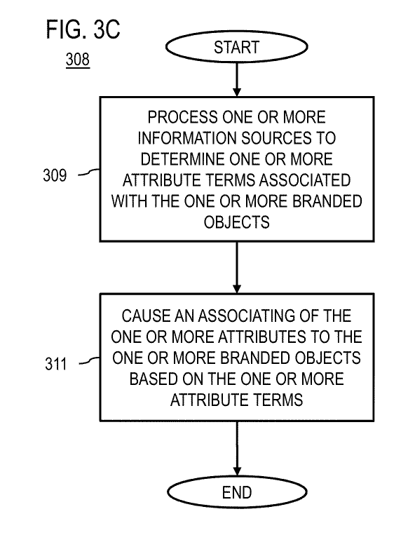

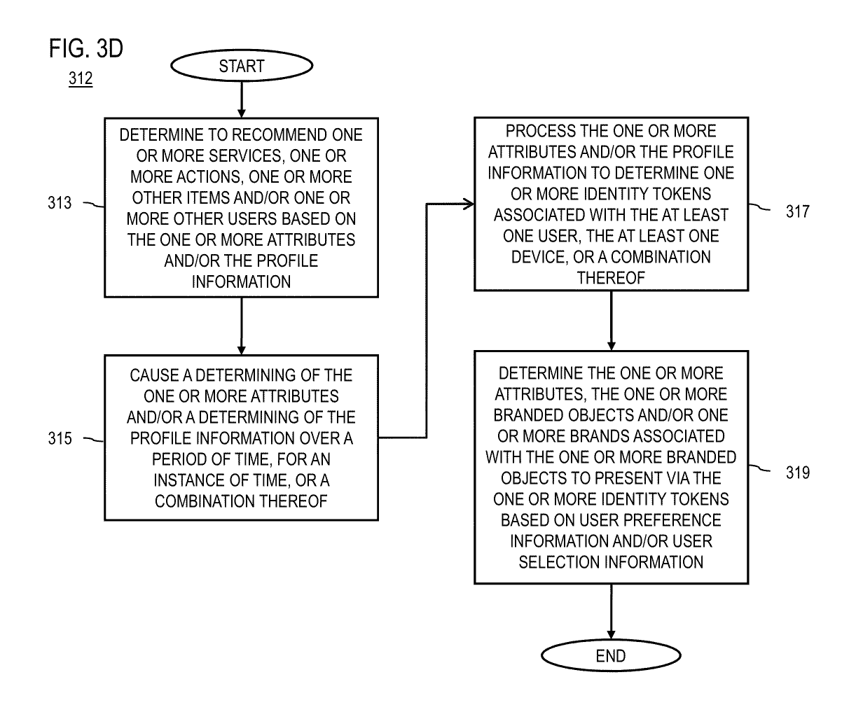

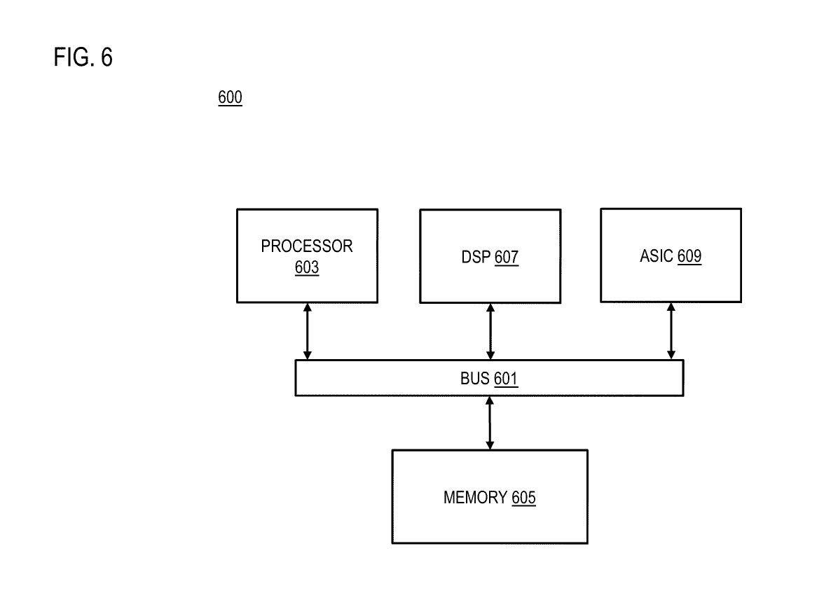

FIGS. 3A-3D are flowcharts of a process for associating one or more attributes of a brand with one or more users, according to various embodiments. In one embodiment, the brand association platform 103 (also referred to herein as platform 103) performs processes 300, 304, 308 and 312 and is implemented in, for instance, a chip set including a processor and a memory as shown in FIG. 6.

In step 301 of process 300 (FIG. 3A), the platform 103 determines one or more attributes for one or more branded objects associated with at least one user and/or at least one device associated with the at least one user. As noted, this determination is based on lookup of the attributes from the brand database 118 of the platform 103. In addition, the attributes are further retrieved based on analysis of one or more documents and/or information maintained by designated content providers 115. In another step 303, the platform 103 processes the one or more attributes to determine profile information associated with the at least one user and/or at least one device. By way of example, this entails matching the attributes of various brands with those incorporated for reference as profile information pertaining to the user.

In step 305 of process 304 (FIG. 3B), the platform 103 causes a discovery of the one or more branded objects using local connectivity. As noted previously, the one or more attributes is determined over the local connectivity, including the transference of metadata, promotional information and any other information related to a branded object. The local connectivity includes, at least in part, near-field communications (NFC), short range wireless communications, or a combination thereof. It is also contemplated that wired communication may also be employed for facilitating the discovery process—i.e., metadata is discovered for a desktop computer when the user plugs their UE 101 into the universal serial bus (USB) port of the computer.

In step 307, the platform 103 determines sensor information captured for the one or more branded objects. As noted previously, the discovery of the one or more branded objects, the one or more attributes, or a combination thereof is further based on the sensor information. The sensor information includes, at least in part, camera sensor information, audio sensor information, fragrance sensor information, taste sensor information, or a combination thereof. Still further, the sensor information may be utilized by the platform 103 to determine contextual information associated with the user, the UE 101, or a combination thereof. As such, it is contemplated that brand-based identity tokens, recommendations, and other actions invoked by a service and/or application on the basis of one or more attributes may be adapted to real-time conditions of the user. Under this scenario, for example, a recommendation for the user to purchase a branded object associated with the term “fun” may be adapted to befit nighttime hours. As such, the recommendation may include a graphic or text depicting the branded object as a source of nighttime fun rather than daytime fun.

In step 309 of process 308, the platform 103 processes data from one or more information sources to determine one or more attribute terms associated with the one or more branded objects. As noted, the one or more information sources include, at least in part, advertising information, web content, social networking information, review information, or a combination thereof. Per step 311, the platform 103 causes an associating of the one or more attributes to the one or more branded objects based on the one or more attribute terms. It is noted that the attribute terms are descriptors (e.g., adjectives, phrases, taglines) of the one or more attributes—for conveying a specific perception and/or value.

In step 311 of process 312 (FIG. 3D), the platform 103 determines to recommend one or more services, one or more actions, one or more other items and/or one or more other users based on the one or more attributes and/or the profile information. The platform then causes a determining of the one or more attributes and/or a determining of the profile information over a period of time, for an instance of time, or a combination thereof. This corresponds to step 315.

Per step 315, the platform 103 processes the one or more attributes and/or the profile information to determine one or more identity tokens associated with the at least one user, the at least one device, or a combination thereof. As noted, the identity tokens are generated based on the brand data 118. Hence, per step 319, the platform 103 determines the one or more attributes, the one or more branded objects and/or one or more brands associated with the one or more branded objects to present via the one or more identity tokens based on user preference information and/or user selection information. The user selection corresponds to a presentment of one or more brands based identify tokens and subsequent selection of at least one for use in connection with an application and/or service (e.g., social networking service). FIGS. 4A-4H are diagrams depicting various use cases for associating one or more attributes of a brand with one or more users, according to various embodiments. For the purpose of illustration, diagrams 4A-4D are described with respect to an exemplary use case of a user triggering accessing of the brand association platform 103 based on interaction with a memory tagged luxury vehicle.

In FIG. 4A, the user interacts with their luxury sports car, which corresponds to the SuperCar brand and model type as manufactured by Acme Cars. The user has a set of NFC enabled car keys 403, which upon being read to facilitate entry of the user, causes the brand and product information to be conveyed to a mobile device 400 of the user via the NFC connection. The mobile device 400, as shown in FIG. 4B, interfaces with the brand association platform 103. Under this scenario, the brand association platform 103 performs a lookup of attributes associated with the specific brand (SuperCar) or manufacturer information (Acme Cars) and determines the following attributes are associated: “sporting,” “performance,” “enthusiast,” “luxury,” “exclusive” and “prestige.” Resultantly, the platform 103 causes the profile information of the user to be updated to reference these attribute terms accordingly. It is noted that the profile information for a user may be maintained by the brand association platform 103 directly, but eh the mobile device 400, or a combination thereof.

At a later time, the user plots a route via a routing application to travel between London and Bristol. The routing application is presented to the display 407 of the device 400, and may also be configured to cause the gathering of location information, position information, speed information, and other details regarding the device 400 and/or the user. Upon selecting the TURN-BY-TURN DIRECTIONS action button 409, the routing application causes a rendering of one or more route recommendations to the user as shown in FIG. 4C. Two of the routes are based on accessing of profile information for the user to reflect and/or incorporate various points-of-interest (POIs) or other navigation elements related to the brand attributes of the user.

As shown in FIG. 4C, the user is presented with a map 411 for depicting three different routes labeled (1), (2) and (3) that the user may user to reach their destination. Corresponding details for each of the routes is also presented as various links 413. The first route, labeled (1) is the fastest route from London to Bristol. This is the default route generated by the routing application. The second route, labeled (2), is presented as the “Ultimate Fine Dining Route.” This is a route generated based on the determined attributes associated with the user of “luxury” and “prestige,” and corresponds to a route featuring various restaurants associated with the same attributes. The third route, labeled (3), is presented as the “Open Road Breakout Route.” This is a route generated based on the determined attributes associated with the user of “sporting,” “performance,” and “enthusiast,” and corresponds to a route that features open roadways for travel. It is noted that this route is presented despite being the least effective distance to the destination. Nonetheless, the routing application is able to present this option as a means of accommodating the determined brand attributes that befit the user of the device 400 and driver of the car 401.

The attributes of the route may be determined in a number of ways including:
Previous users who share the same attributes or use the same brands nominate a route;
Attribute mining techniques are used for determining POIs; for example, a user with a prestigious car may wish to visit restaurants associated with a similar/same attribute
Existing tags and metadata are used from pre-existing mapping systems
The attributes are inferred from statistics such as the ratio of the average speed, the number of bends of the road, average traffic volume, etc.

In FIG. 4D, the display is shown when the user selects the route labeled (2), corresponding to the “Ultimate Fine Dining Route.” Under this scenario, the user is presented with details regarding the route as well as details regarding the brand attributes 415 upon which the route is based. In addition, location information and other contextual data are used to determine the user is within proximity of a clothing store that is also aligned with the various attributes 415. As a result, a custom offer 417 is presented for display to the user in association with or as a point-of-interest along the route.

For the purpose of illustration, diagrams 4E-4G are described with respect to an exemplary use case of a user triggering accessing of the brand association platform 103 based on interaction with a laptop computer. In FIG. 4E, the user transfers an image 421 from their mobile device 400 to their laptop computer, which corresponds to the SuperPC brand and model type as manufactured by Acme PC. The image is sent by way of an imaging application of the device 400 via a short-range communication protocol (e.g., infrared, Bluetooth). During the exchange, the brand, branded object type and manufacturer information are passed from the computer to the mobile device, which is connected to the brand association platform 103. Resultantly, the brand attributes of “professional,” “premium” and “style” are returned to the calling application (e.g., the imaging application) and used to update the user's profile. Under this scenario, the profile information is maintained at the device 400 although, alternatively, it may be maintained by a service platform 111 or the brand association platform 103.

At a later time, the user activates a location service application to receive recommendations for restaurants in their local area. This is shown, by way of example, in FIG. 4F. The user may enter their search criteria as well as select a SEARCH action button to begin the search process. Also, based on the sensor information for indicating their present location along with the attributes associated with the user, the user is presented with an option to include restaurants which match their brand profile. By way of example, the user may activate this option by selecting the checkbox 425.

Once the user activates the search button 423, they are presented with various restaurant matches that correspond to the search criteria. This includes, for example, various recommendations 427 of restaurants that have been discussed on the internet using terms equivalent or semantically similar to the determined attributes 429 of “professional,” “premium” and “style.”

FIG. 4E depicts various brand identity tokens generated for use in connection with one or more application and/or services based on determined brand attributes of the user. For the purpose of illustration, an identity tracker client of an application facilitates the retrieval and/or generation of the identity tokens in connection with the brand association platform 103. As such, combinations of brand affiliations, brand attributes and brand related behaviors are translated to a brand identity token, which may be used for self-presentational purposes.

Under this scenario, the user can select between various brand identity tokens as generated (automatically) in response to updated profile information for the user. The first brand identity token 431 is generated based on the determination that the user owns a SuperCar X200. Under this scenario, the brand identity token as selected by the user is one wherein the brand and product type are emphasized. Also, since low fuel consumption is a key product attribute for this model, the characteristics of the use of the car are transmitted to the identity tracker client accordingly. This enables association of the brand identity token with personalized information that corresponds with the efficiency theme.

In the second identity token 433, two different key brands affiliated with the user are communicated. The list is generated automatically based on the brands observed to be used by the individual. In the third identity token 435, various recommendations of brands identified as liked by the user are presented as a list based on brand attributes identified for the user. Under this scenario, the brands identified as recommended by the user are based on acceptance of the recommendation items using a preference indicator of the user's social networking service (e.g., the “Like” feature of Facebook). In certain embodiments, this brand identity token hides the actual brands based on which recommendations have been produced.

The processes described herein for associating one or more attributes of a brand with one or more users may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

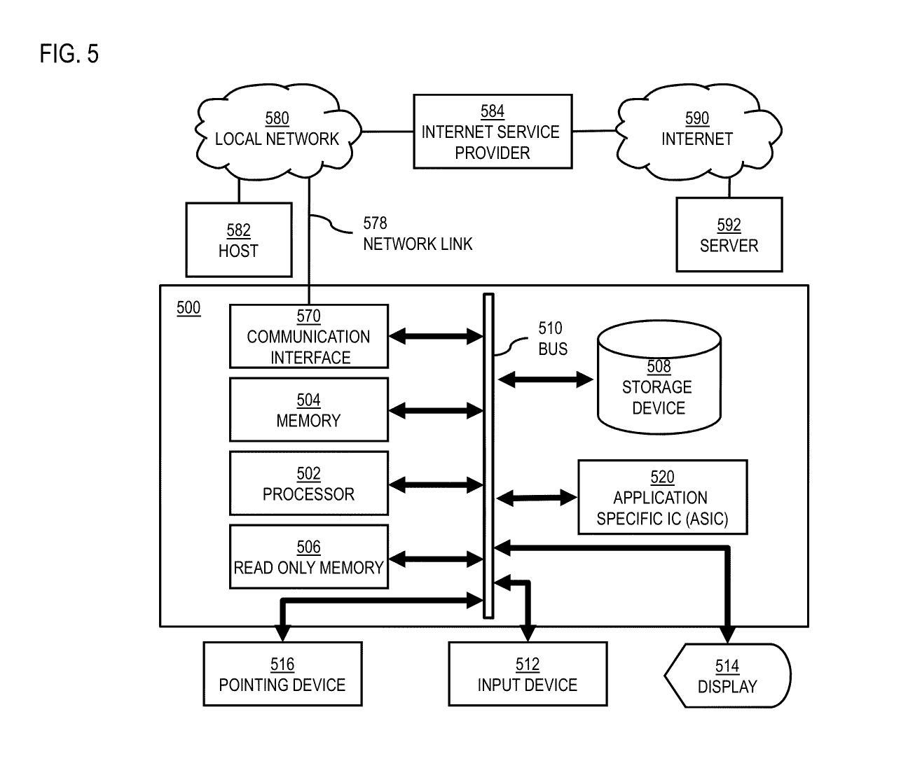

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to associate one or more attributes of a brand with one or more users as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of associating one or more attributes of a brand with one or more users.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to associate one or more attributes of a brand with one or more users. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for associating one or more attributes of a brand with one or more users. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for associating one or more attributes of a brand with one or more users, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for associating one or more attributes of a brand with one or more users to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to associate one or more attributes of a brand with one or more users as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of associating one or more attributes of a brand with one or more users.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to associate one or more attributes of a brand with one or more users. The memory 605 also stores the data associated with or generated by the execution of the inventive steps.

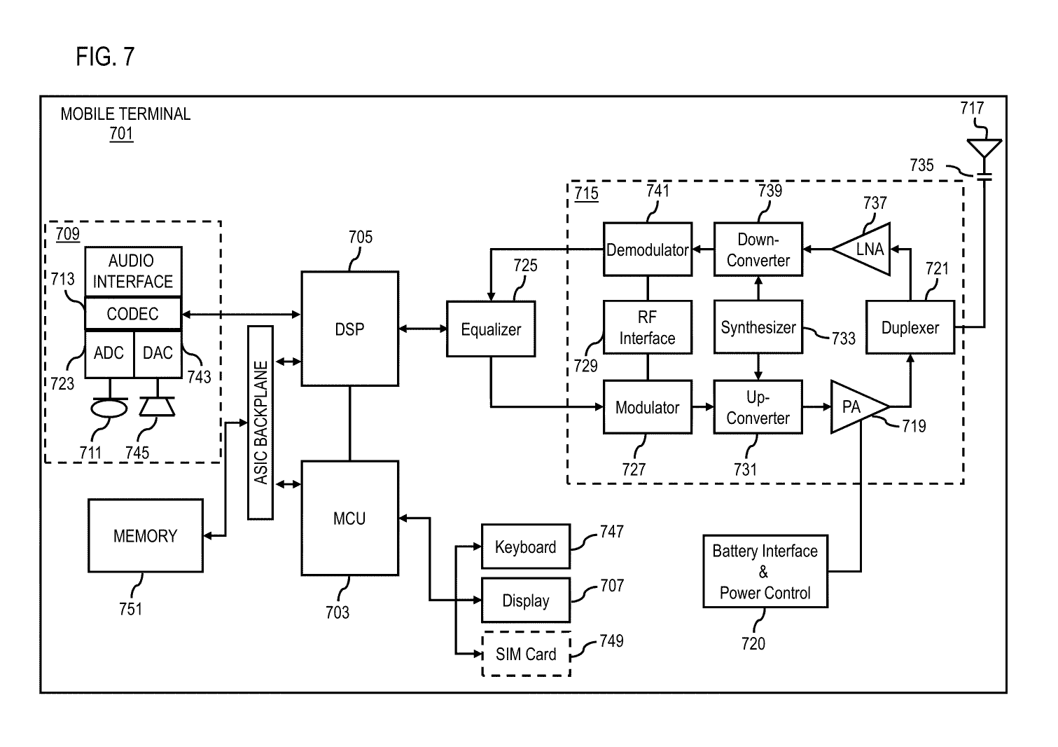

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of associating one or more attributes of a brand with one or more users. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of associating one or more attributes of a brand with one or more users. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to associate one or more attributes of a brand with one or more users. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing, by a processor, (1) data and/or (2) information and/or (3) at least one signal, the (1) data and/or (2) information and/or (3) at least one signal based, at least in part, on the following:
at least one determination of one or more attributes for one or more brands associated with one or more interactions of at least one user, at least one device associated with the at least one user, or a combination thereof with one or more branded objects;
a creation of an index of the one or more attributes associated with the one or more brands;
at least one determination of one or more antonym terms based, at least in part, on the one or more attributes;
a processing, by the processor, of the one or more attributes to determine profile information associated with the at least one user, the at least one device, or a combination thereof; and
a recommendation of one or more services, one or more actions, one or more other items, one or more other users, or a combination thereof based, at least in part, on the one or more antonym terms and the profile information.

2. A method of claim 1, wherein the (1) data and/or (2) information and/or (3) at least one signal are further based, at least in part, on the following:
a discovery of the one or more branded objects using, at least in part, local connectivity,
wherein the one or more attributes are determined over the local connectivity.

3. A method of claim 2, wherein the local connectivity includes, at least in part, near-field communications, short range wireless communications, or a combination thereof.

4. A method of claim 2, wherein the (1) data and/or (2) information and/or (3) at least one signal are further based, at least in part, on the following:
at least one determination of sensor information captured for the one or more branded objects,
wherein the discovery of the one or more branded objects, the one or more attributes, or a combination thereof are further based, at least in part, on the sensor information; and
wherein the sensor information includes, at least in part, camera sensor information, audio sensor information, fragrance sensor information, taste sensor information, or a combination thereof.

5. A method of claim 1, wherein the (1) data and/or (2) information and/or (3) at least one signal are further based, at least in part, on the following:
a processing of one or more information sources to determine one or more attribute terms associated with the one or more branded objects, wherein the one or more attribute terms are descriptive of the one or more attributes; and
causing, at least in part, an association of the one or more attributes to the one or more branded objects based, at least in part, on the one or more attribute terms.

6. A method of claim 5, wherein the one or more information sources include, at least in part, advertising information, web content, social networking information, review information, or a combination thereof.

7. (canceled)

8. A method of claim 1, wherein the (1) data and/or (2) information and/or (3) at least one signal are further based, at least in part, on the following:
at least one determination of the one or more attributes, a determination of the profile information, or a combination thereof (a) over a period of time, (b) for an instance of time, or (c) a combination thereof.

9. A method of claim 1, wherein the (1) data and/or (2) information and/or (3) at least one signal are further based, at least in part, on the following:
a processing of the one or more attributes, the profile information, or a combination thereof to determine one or more identity tokens associated with the at least one user, the at least one device, or a combination thereof.

10. A method of claim 9, wherein the (1) data and/or (2) information and/or (3) at least one signal are further based, at least in part, on the following:
at least one determination of the one or more attributes, the one or more branded objects, one or more brands associated with the one or more branded objects, or a combination thereof to present via the one or more identity tokens based, at least in part, on user preference information, user selection information, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine one or more attributes for one or more brands associated with one or more interactions of at least one user, at least one device associated with the at least one user, or a combination thereof with one or more branded objects;
cause, at least in part, a creation of an index of the one or more attributes associated with the one or more brands;
determine one or more antonym terms based, at least in part, on the one or more attributes;
process and/or facilitate a processing of the one or more attributes to determine profile information associated with the at least one user, the at least one device, or a combination thereof; and
cause, at least in part, a recommendation of one or more services, one or more actions, one or more other items, one or more other users, or a combination thereof based, at least in part, on the one or more antonym terms and the profile information.

12. An apparatus of claim 11, wherein the apparatus is further caused to:
cause, at least in part, a discovery of the one or more branded objects using, at least in part, local connectivity,
wherein the one or more attributes are determined over the local connectivity.

13. An apparatus of claim 12, wherein the local connectivity includes, at least in part, near-field communications, short range wireless communications, or a combination thereof.

14. An apparatus of claim 12, wherein the apparatus is further caused to:
determine sensor information captured for the one or more branded objects,
wherein the discovery of the one or more branded objects, the one or more attributes, or a combination thereof are further based, at least in part, on the sensor information; and
wherein the sensor information includes, at least in part, camera sensor information, audio sensor information, fragrance sensor information, taste sensor information, or a combination thereof.

15. An apparatus of claim 11, wherein the apparatus is further caused to:
process and/or facilitate a processing of one or more information sources to determine one or more attribute terms associated with the one or more branded objects, wherein the one or more attribute terms are descriptive of the one or more attributes; and
cause, at least in part, an association of the one or more attributes to the one or more branded objects based, at least in part, on the one or more attribute terms.

16. An apparatus of claim 15, wherein the one or more information sources include, at least in part, advertising information, web content, social networking information, review information, or a combination thereof.

17. (canceled)

18. An apparatus of claim 11, wherein the apparatus is further caused to:
cause, at least in part, a determination of the one or more attributes, a determination of the profile information, or a combination thereof (a) over a period of time, (b) for an instance of time, or (c) a combination thereof.

19. An apparatus of claim 11, wherein the apparatus is further caused to:
process and/or facilitate a processing of the one or more attributes, the profile information, or a combination thereof to determine one or more identity tokens associated with the at least one user, the at least one device, or a combination thereof.

20. An apparatus of claim 19, wherein the apparatus is further caused to:
determine the one or more attributes, the one or more branded objects, one or more brands associated with the one or more branded objects, or a combination thereof to present via the one or more identity tokens based, at least in part, on user preference information, user selection information, or a combination thereof.

21-48. (canceled)
